(19) United States
(12) Patent Application Publication
(10) Pub. No.: US 2009/0139582 A1
(43) Pub. Date: Jun. 4, 2009

(54) INFLATION VALVE ASSEMBLY

(76) Inventors: Thomas B. Franta, Cloquet, WI (US); Lyle Underwood, Chili, MN (US); Justin Boortz, Waconia, MN (US); Brandon Underwood, Wisconsin Rapids, WI (US)

Correspondence Address: SHERRILL LAW OFFICES, 4756 BANNING AVE, SUITE 212, WHITE BEAR LAKE, MN, 55110-3205, US

(21) Appl. No.: 11/947,991

(22) Filed: Nov. 30, 2007

(51) Int. Cl. F16K 15/20

(52) U.S. Cl. 137/232

(57) ABSTRACT

An inflation valve assembly comprises a longitudinally extending conduit, a cap, a normally closed elastic double-duckbill valve, and a hollow nozzle insert. The longitudinally extending conduit has a first longitudinal end and a second longitudinal end. The cap is configured and arranged for removable attachment to the first longitudinal end of the conduit. The normally closed elastic double-duckbill valve sealingly engages within the conduit with intersecting radially elongated slits extending longitudinally there through. The hollow nozzle insert is configured and arranged for longitudinal insertion into the conduit through the first longitudinal end for separating both slits and opening the double-duckbill valve so long as the nozzle insert remains inserted within the conduit.

### BACKGROUND

Transporting large amounts of cargo in trucks, railroad cars, and ships is an economical way of moving goods from one location to another. The cargo is often stored in large compartments. Unfortunately, the normal movement of the trucks, railroad cars, and ships can shift the cargo during transport and damage the goods being moved. To solve this problem large dunnage or cargo bags filled with air are inserted between the goods or the containers holding the goods to prevent movement or shifting during transport. The dunnage bags are typically installed empty into the empty spaces between the goods or containers and then filled with air using a foot pump, hand pump, or compressor. After the goods arrive at the intended destination the air needs to be removed from the dunnage bags to allow the goods or containers to be removed. Typically the dunnage bags are punctured to remove the air or the air is evacuated from the dunnage bag using a vacuum device.

Puncturing the dunnage bag to evacuate the air can be difficult in the often limited space available and can take considerable time. Puncturing the dunnage bag also renders the bag as a single use dunnage bag and increases the cost of transportation.

Typically reusable dunnage bags are used. To decrease the time to deflate the dunnage bag a vacuum device is often used. The valves for such use are known in the trade. Examples of available valves include the typical one-way valve flap as used in inflatable toys. To deflate a dunnage bag with such a valve requires the valve be deformed or completely removed to allow the air to escape. Both types are problematic. The deformable valve needs to remain deformed to allow complete evacuation of air. The removable valve may be lost or difficult to reattach.

The invention disclosed in U.S. Pat. No. 6,823,905 ('905 patent) attempts to solve the valve problems associated with the deformable valve and the removable valve. The '905 patent discloses a flapper valve attached to the dunnage bag. The flapper valve is biased closed and then is pushed open with a finger or the compressor nozzle. The nozzle may then be inserted into the dunnage bag and air introduced to inflate the bag. As the air pressure in the bag increases it will close the flapper valve and hold it shut to prevent the air from escaping from the dunnage bag. When the bag needs to be deflated the flapper valve must be forced open with a finger or other object to allow the air to escape or be removed. A major drawback of the flapper valve is that the flap does not allow the opening to be fully open and it extends into the dunnage bag to allow the bag to be inflated and deflated impedes the flow of air into and out of the bag increasing the time for inflation and deflation.

Therefore, what is needed is a dunnage bag valve that allows unimpeded air flow into and out of the bag to decrease the time needed to inflate and deflate the bag.

### SUMMARY OF THE INVENTION

One embodiment of the invention is an inflation valve assembly having a longitudinally extending conduit, a cap, a normally closed elastic double-duckbill valve, and a hollow nozzle insert. The longitudinally extending conduit has a first longitudinal end and a second longitudinal end. The cap is configured and arranged for removable attachment to the first longitudinal end of the conduit. The normally closed elastic double-duckbill valve sealingly engages within the conduit with intersecting radially elongated slits extending longitudinally there through. The hollow nozzle insert is configured and arranged for longitudinal insertion into the conduit through the first longitudinal end for separating both slits and opening the double-duckbill valve so long as the nozzle insert remains inserted within the conduit.

### BRIEF DESCRIPTION OF THE DRAWINGS

FIG. 1 is a side perspective view of the assembly.

FIG. 2 is a side perspective view of the conduit in FIG. 1.

FIG. 3 is a side perspective view of the conduit in FIG. 2 with the double-duck-bill valve sealingly engaging within the conduit.

FIG. 4 is a side perspective view of the double-duck bill valve in FIG. 3.

FIG. 5 is a bottom view of the valve in FIG. 4.

FIG. 6 is side view of the hollow nozzle insert in FIG. 1.

FIG. 7 is a side view of the hollow insert in FIG. 6 inserted within the valve in FIG. 4.

FIG. 8 is a top perspective view of the cap attached to the first longitudinal end of the conduit in FIG. 1.

### DETAILED DESCRIPTION OF A PREFERRED EMBODIMENT

### Nomenclature

10 Valve assembly
20 Conduit
21 First end
22 Second end
23 Mounting flange
24 Outer surface
25 Groove
30 Cap
31 Attachment band
32 Hinge
33 Lid
40 Double-duckbill valve
41 First duckbill structure
41a Inclined wall
42 Second duckbill structure
42a Inclined wall
43 First apex
44 Second apex
46 First slit
47 Second slit
50 Nozzle insert
51 Positioning flange
52 Outer surface
53 First end
54 Second end
X Longitudinal direction
Y₁ First lateral plane
Y₂ Second lateral plane

### Construction

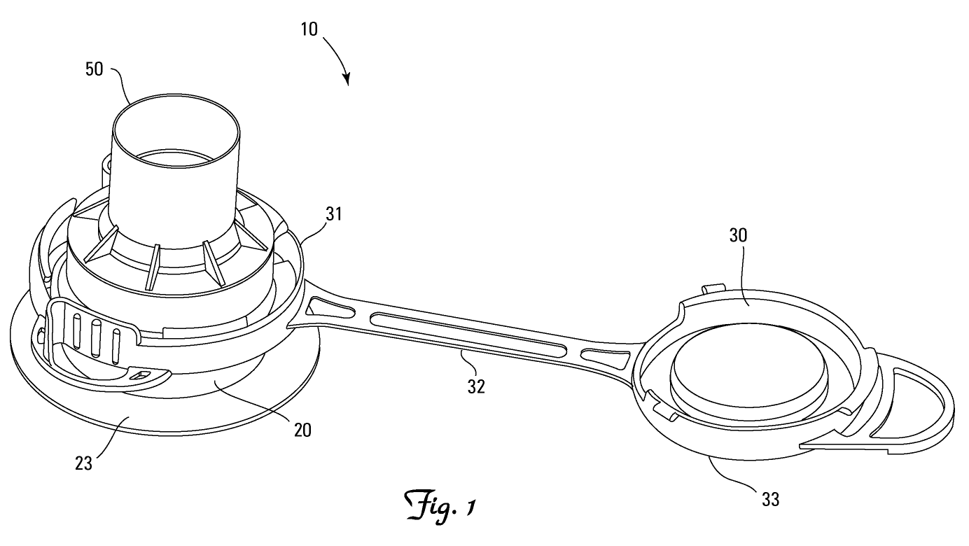

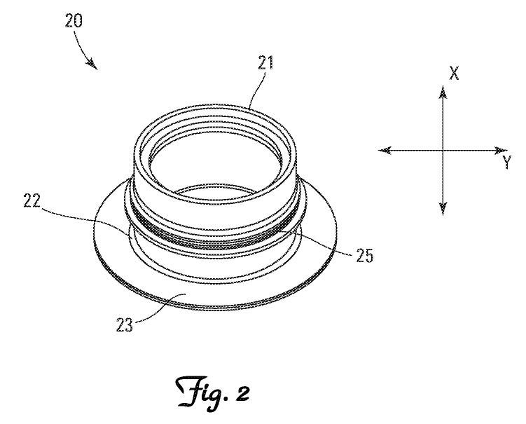

As shown in FIG. 1, one embodiment of the inflation valve assembly 10 has a longitudinally X extending conduit, a cap 30, a normally closed elastic double duckbill valve 40, and a hollow nozzle insert 50. As shown in FIG. 2, the conduit 20 may have a first longitudinal X end 21 and a second longitudinal X end 22. The conduit 20 may also have an annular mounting flange 23 attached to the outer surface 24 of the conduit 20 proximate the second longitudinal X end 22 of the conduit 20 and radially extending in a first lateral plane Y₁ from the conduit 20. Preferably the flange 23 is configured and arranged to be heat-sealed to an interior or exterior portion of one of the plies of an inflatable bladder of a dunnage bag.

The conduit 20 may be made from any suitable material such as metal or plastic. The most preferred material is polyethylene. The conduit 20 may have nay suitable circumference shape such as an oval, polygon, or circle. The preferred shape is circular.

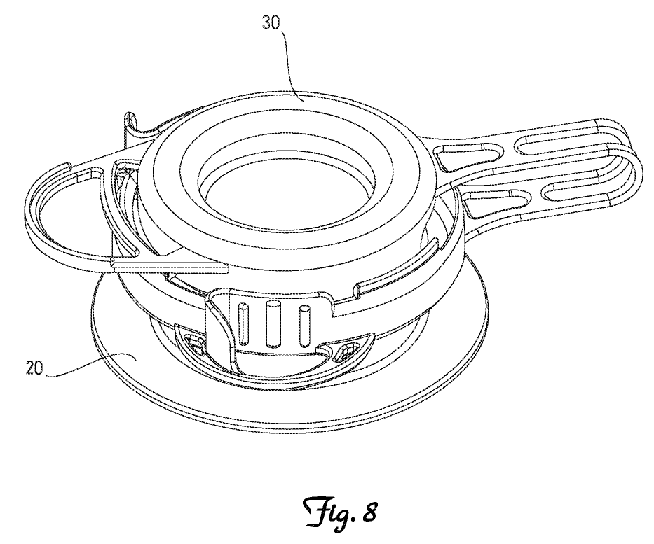

As shown in FIG. 1, the assembly 10 has a cap 30. The cap 30 is configured and arranged for removable attachment to the conduit 20. Preferably the cap 30 has an attachment band 31 configured and arranged to removably attach to a groove 25 around the outer surface 24 of the conduit 20. As shown in FIG. 1, the attachment band 31 is then attached to a distal end of a hinge 32. The proximal end of the hinge 32 may then be attached to a lid 33 of the cap 30. As shown in FIGS. 1 and 8, the lid 33 may be configured and arranged to sealingly engage the first longitudinal X end 21 of the conduit 20 to prevent air from entering or leaving the conduit 20 when the conduit 20 is attached to a dunnage bag. The cap 30 may be made from any suitable material such as plastic or rubber. The preferred material is plastic.

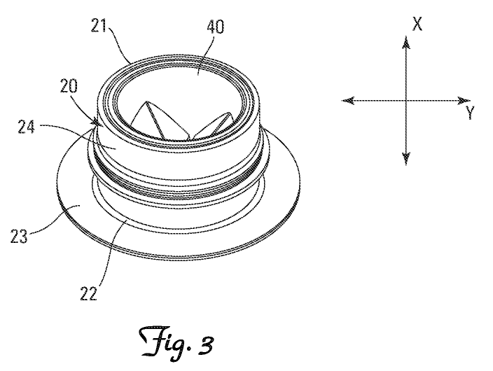

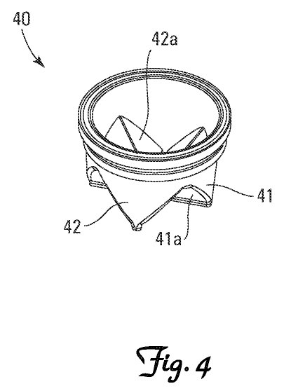

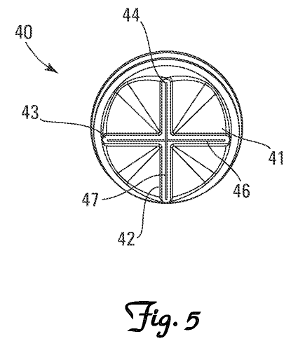

As shown in FIG. 3, the assembly 10 also has a normally closed elastic double duck-bill valve 40. As shown in FIG. 4, preferably the valve 40 may have a first hollow duckbill structure 41 and a second hollow duckbill structure 42. The first duckbill structure 41 has a first pair of inclining walls 41a terminating at a first apex 43. The second duckbill structure 42 has a second pair of inclined walls 42a terminating at a second apex 44. The first apex 43 may have a radially elongated first slit 46 extending longitudinally X there through. The second apex 44 may have a radially elongated second slit 47 extending through. The slits 46, 47 may then be intersecting. As shown in FIG. 5, most preferably the radially elongated first and second slits 46, 47 intersect orthogonally. The valve 40 may also be configured and arranged to engage the conduit 20 such that the first pair of inclined walls 41a and second pair of inclined walls 42a incline toward the second longitudinal X end 22 of the conduit 20. Most preferably the double-duckbill valve 40 does not extend beyond the second longitudinal X end 22 of the conduit 20.

The double-duckbill valve 40 may be made from any suitable material such as rubber or elastic plastic. The most preferred material is a thermal plastic elastimer.

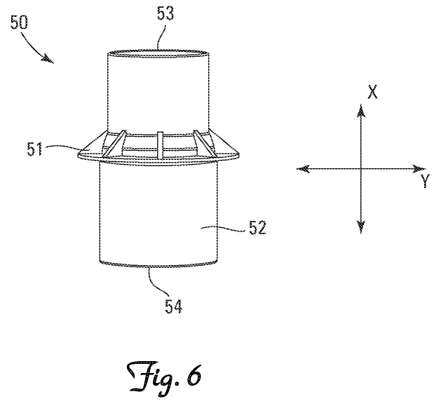

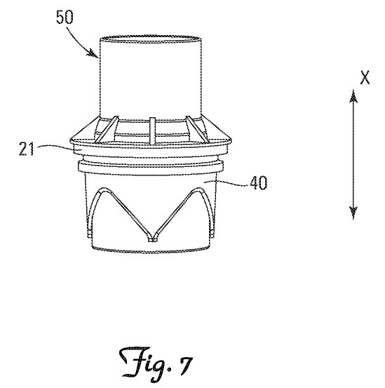

As shown in FIGS. 1 and 6, the assembly 10 may also have a hollow nozzle insert 50. The insert 50 may be configured and arranged for longitudinal X insertion into the conduit 20 through the first longitudinal X end 21 of the conduit 20 for separating both the first and second slits 46, 47 and opening the double-duckbill valve 40 so long as the nozzle insert 50 remains inserted within the conduit 20. The nozzle insert 50 may have a first longitudinal X end 53 and a second longitudinal X end 54. Preferably the first longitudinal X end 53 is configured and arranged for removable attachment to a pressurized air source. As shown in FIG. 7, the second longitudinal X end 54 may be configured and arranged to be inserted into the conduit 20 and the double-duckbill valve 40 to completely separate and open the first and second slits 46, 47 through the valve 40.

As shown in FIG. 6, the preferred nozzle insert 50 has an annular positioning flange 51 attached to the outer surface 52 of the nozzle insert 50 between the first longitudinal X end 53 and the second longitudinal X end 54 of the nozzle insert 50 and radially extending in a second lateral plane Y₂ from the nozzle insert 50. As shown in FIG. 1, the positioning flange 51 may be configured and arranged to be supported by the first longitudinal X end 21 of the conduit 20 when inserted longitudinally X into the conduit 20.

Preferably the positioning flange 51 on the nozzle insert 50 is attached to the outer surface 52 between the first longitudinal X end 53 and second longitudinal X end 54 such that when inserted into the conduit 20 the double-duckbill valve 40 first and second slits 46, 47 are fully open and the second longitudinal X end 54 of the nozzle insert 50 does not extend past the second longitudinal X end 54 of the nozzle insert 50 to prevent the second longitudinal X end 54 of the nozzle insert 50 from coming into contact with the dunnage bag. Preventing contact between the nozzle insert 50 and the dunnage bag may improve maximum air flow through the nozzle insert 50 into and out of the dunnage bag.

### Use

Dunnage bags (not shown) are known in the industry as a common means to stabilize cargo during transportation. The deflated dunnage bags are inserted between stacks of boxes or between pieces of merchandise or equipment. The dunnage bag needs to be inserted so as to allow access to the inflation valve assembly 10. Once the dunnage bag is in place the lid 33 of the cap 30 on the inflation valve assembly 10 may be removed from the first longitudinal X end 21 of the conduit 20 to allow access to the conduit 20.

The hollow nozzle insert 50 may then be inserted through the first longitudinal X end 21 of the conduit 20 and through the elongated first and second slits 46, 47 of the double-duckbill valve 40 until the positioning flange 51 is supported by the first longitudinal X end 21 of the conduit 20. Insertion into the conduit 20 directs the second end of the nozzle insert 50 into the first hollow duckbill structure 41 and the second duckbill structure 42 to push the first set of inclined walls 41a and the second set of inclined walls 42a laterally outward as shown in FIG. 7 to allow the second end of the nozzle insert 50 to fully separate the first and second slits 46, 47 in the first apex 43 and second apex 44 of the valve 40. The double-duckbill valve 40 may now be fully open without causing staining or stretching of the valve 40 to reduce the chance of rips in the valve 40.

Once the nozzle insert 50 is fully inserted into the conduit 20 and the valve 40, a pressurized air source may be attached to the first longitudinal X end 53 of the nozzle insert 50. The nozzle insert 50 may also be attached to the pressurized air source prior to insertion into the conduit 20. Pressurized air may then be forced into the dunnage bag through the nozzle insert 50 and the double-duckbill valve 40. Once the dunnage bag is inflated to the desired firmness, the nozzle insert 50 may be removed from the conduit 20 and the double duckbill valve 40. As the second end of the nozzle insert 50 is withdrawn from the conduit 20 and the valve 40, the elastic double-duckbill valve 40 returns to its normally closed position. The closed double-duckbill valve 40 may prevent air from leaving the dunnage bag.

The lid 33 on the cap 30 may then be attached to the first end of the longitudinal X end of the conduit 20 to seal the inflation valve assembly 10 incase there is leakage from the double-duckbill valve 40 and prevent escape of the pressurized air in the dunnage bag through the conduit 20 and valve 40.

Once the cargo arrives at the desired destination the dunnage bag may need to be deflated to allow the boxes or merchandise to be removed. The lid 33 may then be removed from the conduit 20. The nozzle insert 50 may then be reinserted into the conduit 20 and valve 40 to fully open the valve 40. The pressurized air may be allowed to escape on its own or a vacuum source may be attached to the first end of the nozzle insert 50 to evacuate the air from the dunnage bag in a more expedited manner. Once the air is removed, the lid 33 may again be attached to the conduit 20 to prevent debris from entering the dunnage bag until the bag needs used again.

I claim:

1. An inflation valve assembly, comprising:
(a) a longitudinally extending conduit having a first longitudinal end and a second longitudinal end;
(b) a cap configured and arranged for removable attachment to the first longitudinal end of the conduit;
(c) a normally closed elastic double-duckbill valve sealingly engaging within the conduit with intersecting radially elongated slits extending longitudinally there through; and
(d) a hollow nozzle insert configured and arranged for longitudinal insertion into the conduit through the first longitudinal end for separating both slits and opening the double-duckbill valve so long as the nozzle insert remains inserted within the conduit.

2. The inflation valve assembly, as recited in claim 1, wherein the conduit has an mounting flange attached to an outer surface of the conduit proximate the second longitudinal end and extending in a lateral plane from the conduit.

3. The inflation valve assembly, as recited in claim 2, wherein the mounting flange is annular and radially extends in a first lateral plane from the conduit.

4. The inflation valve assembly, as recited in claim 1, wherein (i) the double-duckbill valve has a first hollow duckbill structure having a first pair of inclined walls terminating at a first apex, a second hollow duckbill structure oriented perpendicular to the first duckbill structure and having a second pair of inclined walls terminating at a second apex, and the intersecting slits extend longitudinally through the first and second apexes and (ii) the double-duckbill valve is configured and arranged to engage the conduit such that the first and second pair of inclined walls incline toward the second longitudinal end of the conduit.

5. The inflation valve assembly, as recited in claim 1, wherein the double-duckbill valve has orthogonally intersecting radially elongated slits.

6. The inflation valve assembly, as recited in claim 1, wherein the hollow nozzle insert has a positioning flange attached to an outer surface of the nozzle between a first longitudinal end and a second longitudinal end of the nozzle and extending in a lateral plane from the nozzle and the positioning flange is configured and arranged to be supported by the first longitudinal end of the conduit when inserted longitudinally into the conduit.

7. The inflation valve assembly, as recited in claim 6, wherein the positioning valve is annular and radially extends in a second lateral plane from the nozzle.
